(19) United States
(12) Patent Application Publication
(10) Pub. No.: US 2018/0269825 A1
(43) Pub. Date: Sep. 20, 2018

(54) SOLAR MODULE ARRANGEMENT AND METHOD OF ASSEMBLING A SOLAR MODULE ARRANGEMENT

(71) Applicant: Mirko Dudas, München (DE)

(72) Inventors: Mirko Dudas, München (DE); Pierre-Alexandre Huhn, München (DE)

(21) Appl. No.: 15/542,238

(22) PCT Filed: Jan. 7, 2016
(86) PCT No.: PCT/EP2016/000044

§ 371 Date: Jul. 7, 2017

(30) Foreign Application Priority Data
Jan. 14, 2015 (DE) 10 2015 000 413.1

(51) Int. Cl. H02S 30/10; F24S 25/12; F24S 25/33; H02S 20/23; H02S 20/10

(52) U.S. Cl. CPC H02S 30/10; F24S 25/12; F24S 2020/11; H02S 20/23; H02S 20/10; F24S 25/33

(57) ABSTRACT

A solar module arrangement (600, 700) is provided which comprises two solar module elements (105, 203, 213, 300, 401, 502, 604, 702, 812) each comprising a frame structure formed by a plurality of side elements and each comprising a main surface, wherein the two solar module (105, 203, 213, 300, 401, 502, 604, 702, 812) elements are assembled adjacent to each other; wherein the main surfaces of the two solar module elements are arranged parallel to each other; and wherein the solar module arrangement is arranged so that the main surface of the solar module elements (105, 203, 213, 300, 401, 502, 604, 702, 812) has a line of the greatest slope which forms a slanted shifting angle with respect to the side element of the frame structure which intersects with the line of the greatest slope.

### TECHNICAL FIELD

The invention relates to a solar module arrangement, in particular to a fixed solar module arrangement.

Furthermore, the invention relates to a method of assembling a solar module arrangement.

Beyond this, the invention relates to a method of reassembling a solar module arrangement.

### BACKGROUND

Both photovoltaic and also solar-thermal energy generation plants are known from the prior art. Both use the incident solar radiation to generate either electrical or thermal energy and supply it to a further consumer. So-called combination modules also exist, which allow a combination of photovoltaic and solar-thermal energy generation. In all modules, an orientation toward the sun which is a function of the geographical usage region is absolutely necessary to optimize the efficiency.

Typically, such modules are mounted elevated on roofs, flat roofs, free surfaces, or also façades in such a way that they have this optimum orientation toward the sun. In order to further optimize the efficiency here, solar energy generation plants are also known, which are actively tracked to the course of the sun, in order to ensure an optimum or at least an improved orientation toward the sun at nearly every time of day.

However, it is problematic in the case of such solar energy generation modules which are mounted elevated, i.e., inclined to the horizontal on one side to the south or north depending on the use on the southern or northern hemisphere, that modules arranged in an array, lose efficiency due to mutual shadowing. Furthermore, such a tracking mechanism used for increasing efficiency is quite complex.

### SUMMARY

There may be a need to provide a solar module arrangement, a method of assembling a solar module arrangement, and a method of reassembling a solar module arrangement which may have a high efficiency and/or a low complexity configuration.

This need may be met by a solar module arrangement, a method of assembling a solar module arrangement, and a method of reassembling a solar module arrangement according to the independent claims. Further exemplary embodiments are described in the dependent claims.

According to an exemplary aspect a solar module arrangement is provided which comprises two solar module elements each comprising a frame structure formed by a plurality of side elements and each comprising a main surface, wherein the two solar module elements are assembled adjacent to each other; wherein the main surfaces of the two solar module elements are arranged parallel to each other; and wherein the solar module arrangement is arranged so that the main surface of the solar module elements has a line of the greatest slope which forms a slanted shifting angle with respect to the side element of the frame structure which intersects with the line of the greatest slope.

It should be noted that the solar module arrangement may of course comprise more than two or a plurality of solar module elements. In particular, the number of solar module elements may depend on the area available and the size of the single solar module element. In particular, the main surfaces of each solar module element may be arranged so that each line of the greatest slope forms a slanted shifting angle with respect to the intersecting side of the respective frame structure. It should be noted that the shifting angles of different solar module elements may be equal or may be different.

In particular, the solar module arrangement may be a fixedly mounted assembly. That is, no tracking or moving mechanism are provided. For example, the solar module arrangement may be mounted or fixed to a roof or a fixed mounting structure set up on ground. It should further be noted that the two or more solar module elements may be arranged in a herringbone pattern, parallel to each other in form of a tile pattern or any other suitable regular or even irregular pattern.

In particular, the line of the greatest slope may have a slope, grade or gradient of more than 0° and less than 45°, preferably between 2° and 30°, more preferably the slope may be in the range between 4° and 15°, e.g. about 8°.

In particular, a single solar module element may be limited by the frame structure, i.e. the frame structure may form the circumferential boundary or a rim of a single solar module element.

The term “slanted shifting angle” may particularly denote an angle which differs from 90°, i.e. which is not perpendicular. Just for clarity reasons it is mentioned that the slanted shifting angle represents a willingly introduced shift or offset and has to be distinguished from an accidental offset or inaccuracy unwillingly introduced. In particular, the shifting angle may be greater than c.

The term “gradient” may particular denote the direction of the greatest derivation or ascent in particular with respect to the gravity field of earth. Thus, the direction of the gradient and the line of the greatest slope are identical.

The term “adjacent” may particularly denote that between two solar module elements being adjacent to each other no other solar module element is arranged. For example, sides of the two adjacent solar module elements may abut each other. However, there may as well a gap or void arranged between the two solar module elements as long as no other solar module element is arranged between.

In particular, the term “parallel” may particularly denote that main surfaces of the respective solar module elements are parallel or at least substantially parallel to each other in space.

According to another exemplary aspect a fixed solar module arrangement is provided which comprises at least two solar module elements each having a planar main surface and having at least one side, wherein the at least two solar module elements are adjacently mounted on a mounting structure, so that the planar main surfaces are equally tilted out of a horizontal plane by tilting the main planar surfaces around two axes out of the group consisting of a first axis perpendicular to the planar main surface; a second axis perpendicular to the first axis and parallel to the at least one side; and a third axis perpendicular to the first and second axis.

The term “axis” or “axes” may particularly denote an axis in a mathematical sense and not a physical element (like a shaft or axle). Further, the axis is defined by an orientation or direction and two lines represent the same axis even when they are parallel shifted with respect to each other.

The term “equally tilted” may particularly denote that the two elements are tilted around the same axis and by the same angle. Thus, in case that two solar module elements are equally tilted the main surfaces of the two solar module elements are parallel after the tilting, but may be parallel shifted to each other.

It should be noted that the solar module elements may be unframed or framed solar module elements, i.e. elements comprising a frame structure having a plurality of side elements. In particular, the frame structure may surround the main surface of the solar module elements.

According to another exemplary aspect a method of assembling a solar module arrangement comprising at least two solar modules each having at least one side and each comprising a main surface, wherein the method comprises providing a mounting structure providing a surface having a plurality of mounting rods thereon for mounting a solar module arrangement; mounting the at least two solar module elements adjacent to each other on the mounting rods so that the main surfaces of the at least two adjacent solar modules are arranged parallel to each other and that the main surfaces of the solar module elements have a line of the greatest slope which forms a slanted shifting angle with respect to the at least one side which intersects with the line of the greatest slope.

It should be noted that the term “mounting rod” may particularly denote any structure suitable to mount the solar module elements on it. For example, a mounting rod may be an additional rod or longitudinal mounting unit or may be a surface structure or surface feature of the mounting structure or surface thereof, e.g. a specific profile of a corrugated sheet roof or the like. Furthermore, it should be noted that the mounting rods may form a straight line or may provide a curved, bent or kinked structure. That is, the form or shape of the mounting rods is not of specific importance as long as the solar module elements can be easily or efficiently mounted or attached thereto. In particular, the solar module element may be a framed or unframed solar module element.

According to an exemplary aspect a method of reassembling a solar module arrangement comprising a plurality of solar module elements each comprising a frame structure formed by a plurality of side elements and each comprising a main surface is provided, wherein the method comprises detaching the plurality of solar module elements attached to a mounting structure in a first orientation from the mounting structure; turning the detached solar module elements into a different second orientation forming an angle of less than 180° with the first orientation; and attaching the plurality of turned solar module elements to the mounting structure in the second orientation.

In particular, the angle may be between 2° and 88°, preferably between 5° and 85°, more preferably between 8° and 10° or preferably between 25° and 65°, more preferably between 35° and 55°, e.g. about 45°.

By arranging the main surface of at least one, several or all solar module elements in a way that the line of the greatest slope does intersect at least one side (e.g. a frame side element, in case of a framed solar module element)in a slanted shifting angle it may be possible to reduce the area of the main surface (forming the active surface of the solar module element) which may be covered by rainwater after a shower. This may in particular the case for a frame structure rising (or extending) a given height above the main surface. Thus, when using common solar module elements having a frame structure rising above the solar module element's main surface rain may collect at the frame structure forming a kind of rim.

In case the side of the frame structure which intersects the line of the greatest slope (e.g. the lower side of the solar module element) is not perpendicular to the line of the greatest slope, the volume of water which can be held by an inclined solar module element will be reduced. Due to this reduced amount of water volume and/or water covered area the area which is effected by pollution or contamination may be reduced. Thus, the overall solar module element and thus the overall solar module arrangement may have a higher efficiency and better performance just because of introducing a slanted shifting angle between the line of the greatest gradient and the side of the frame intersecting the same.

A gist of an exemplary embodiment may be seen in providing a solar module arrangement (which is optionally a fixed assembly) wherein a line of the greatest slope of a main surface of at least one (several or all) framed solar module element intersects with at least one side element of a frame structure of the respective solar module element at an angle greater than 0° but less than 90°. Thus, a solar module arrangement comprising or consisting of some kind of turned or rotated solar module elements is provided. Such a turning, twisting or rotating of the solar module elements may provide for a reduced “backwater effect” of the rim formed by the frame structure, so that less area of the main surface of the solar module element may be covered by rainwater and thus of dirt leading to the possible effect that the efficiency of the solar module element and thus of the overall solar module arrangement may be increased by a simple turning or rotating of common solar module elements. In addition, the turning of the solar module elements may induce an undisturbed flow of the rainwater which may as well remove accumulated dirt or at least reduce the probability that dirt will accumulate.

In the following, further exemplary embodiments of the solar module arrangement will be explained. However, these embodiments also apply to the fixed solar module arrangement the method of assembling or reassembling a solar module arrangement.

According to an exemplary embodiment of the solar module arrangement the frame structure has a rectangular form.

Thus, also the overall solar module element may have a rectangular form or shape. The rectangular form may be easy to manufacture and can be easily arranged in a field while having a high field coverage.

According to an exemplary embodiment of the solar module arrangement the solar module elements comprises mounting elements at at least two neighboring sides of the solar module elements.

According to an exemplary embodiment the solar module arrangement further comprises at least one mounting rod, wherein the mounting elements of neighboring sides of a single solar module element are attached to a single mounting rod.

It should be noted that in a broad sense also a single mounting element arranged on a corner of a single solar module element may be interpreted as being arranged on two neighboring sides and thus may fall under the term “mounting elements of neighboring sides”.

In particular, two other neighboring mounting elements may be attached or fixed to another mounting rod, which is arranged parallel to the at least one mounting rod. For example, each mounting rod may form a straight line. In the case of a rectangular frame structure or solar module element, all sides of the frame structure form a slanted angle with the mounting rods. In case the mounting rod is fixed or arranged parallel to a roof ridge, it may be an efficient way to provide for a slanted shifting angle between the line of greatest slope and the side of the frame structure intersecting the line of greatest slope when two neighboring sides are fixed to a single (straight) mounting rod.

In particular, the mounting elements may be attached to or may form part of the frame structure. Preferably, each side of the solar module elements (or the respective frame structures) comprises at least one mounting or fixing element. This measure may be an efficient way to use standard frame and/or mounting structures. For example, it may be possible to use standard solar module elements and mounting structures for forming a solar module arrangement according to an exemplary embodiment. It may even be possible to rearrange or reassemble the solar module elements of existing solar module assemblies by just detaching the module elements, turning or rotating the same and attaching the same to the same mounting structure, e.g. mounting rods, possibly without modifying the mounting structure.

According to an exemplary embodiment of the solar module arrangement the solar module elements are arranged in the solar module arrangement that the main surface of each of the solar module elements form an inclination angle with respect to a planar surface.

The term “surface” may particularly denote a physical element, e.g. a surface area or a roof or ground section. Contrary to this, the term “plane” may particularly denote a mathematical or virtual plane defined by an equation of plane. In particular, the term “inclination angle” may particularly denote a zenith angle ⊖ or 90°-⊖. Thus, the “inclination angle” may denote a deviation with respect to the horizon or a horizontal plane. For example, the inclination angle may be between 3° and 30° meaning that the respective inclined plane forms an angle of 3° to 30° with a horizontal plane.

According to an exemplary embodiment of the solar module arrangement the inclination angle of each solar module element has the same absolute value.

In particular, the inclination angle may be in the range between 1 degree and 50 degree, preferably in the range between 2 degree and 30 degree, more preferably in the range between 4 and 15 degree, e.g. about 8 or 12 degree. Alternatively, the inclination angles of different solar module elements may be different in absolute value.

According to an exemplary embodiment of the solar module arrangement the inclination angle has the same sign.

Thus, the main surface of each of the solar modules are parallel to each other. In particular, the main surfaces of all solar module element may lay in a single plane (i.e. the solar module elements may form substantially a single planar surface) or the main surfaces of the (some) solar module elements may lay at different levels shifted parallel to each other. For example, some of the solar module elements main surfaces may form a (planar) surface at one level while the one of other solar module elements may form another (planar) surface at another level. In both cases, the main surfaces of the solar module elements are parallel to each other.

According to an exemplary embodiment the solar module arrangement further comprises a third solar module element adjacent one of the two solar module elements, wherein the inclination angles of the third solar module element and the adjacent one of the two solar module elements have opposite signs.

According to an exemplary embodiment of the solar module arrangement the planar surface forms a horizontal plane.

In particular, the term “horizon” or “horizontal” may particular denote that the respective area or direction forms an equipotential surface or line with respect to the gravitational field of earth. For example, the horizontal plane may be formed by a flat roof or platform roof or a ground area on which the solar module arrangement is mounted on. Of course small deviations from a horizontal plane (as typical in this technical field) may be given.

According to an exemplary embodiment of the solar module arrangement the planar surface is inclined with respect to a horizontal plane.

For example, the planar surface may be a slanted roof or may be defined by a mounting structure set on the ground. On this slanted surface, the solar module elements are arranged at an angle differing from zero degree with respect to the planar surface.

According to an exemplary embodiment the solar module arrangement further comprises a plurality of mounting rods each having a longitudinal direction arranged parallel to each other.

According to an exemplary embodiment of the solar module arrangement the at least one side element of each solar module element forms a slanted angle with the longitudinal direction of the plurality of mounting rods.

In particular, the slanted angle may be greater than 5°, preferably more than 10°, more preferably more than 25°, in particular 45° or about 45°.

According to an exemplary embodiment of the solar module arrangement the longitudinal direction is perpendicular to the line of the greatest slope or forms a slanted angle with the line of the greatest slope.

According to an exemplary embodiment of the solar module arrangement the main surfaces of the two solar module elements have a normal vector having a west orientation or east orientation.

In particular, the term “west orientation” and “east orientation” of a vector may particularly denote that the respective vector points in a west direction ±15° and an east direction ±15°, respectively. Thus, the solar module arrangement may form a so-called east-west assembly. Alternatively, the main surfaces of the two solar module elements have a normal vector having a south orientation or north orientation, in the same sense as described above.

### BRIEF DESCRIPTION OF THE DRAWINGS

The aspects defined above and further aspects are apparent from the examples of embodiment to be described hereinafter and are explained with reference to these examples of embodiment.

In the drawings, like reference characters generally refer to the same parts throughout the different views. The drawings are not necessarily to scale. Instead emphasis is generally being placed upon illustrating the principles of the invention. In the following description, various exemplary embodiments are described with reference to the following drawings, in which:

FIGS. 1A and 1B schematically illustrate a comparison between a common solar module arrangement and a solar module arrangement according to an exemplary embodiment;

FIGS. 2A and 2B each schematically illustrates a solar module arrangement according to an exemplary embodiment;

FIGS. 3A to 3C schematically illustrate mounting variants which may be used in a solar module arrangement according to an exemplary embodiment;

FIGS. 4A and 4B each schematically illustrates mounting variant of a field arrangement of a solar module arrangement according to an exemplary embodiment;

FIGS. 5A and 5B schematically illustrate different views of a flat roof mounting of a solar module arrangement according to an exemplary embodiment;

FIG. 6 schematically shows a field arrangement of an east-west arrangement according to an exemplary embodiment;

FIGS. 7A to 7C schematically illustrate different views of a flat roof mounting of a solar module arrangement according to an exemplary embodiment;

FIGS. 8A and 8B schematically illustrate different variants of an arrangement mounted on an inclined surface according to an exemplary embodiment; and

FIG. 9 depicts a flowchart of a method of assembling a solar module arrangement according to an exemplary embodiment.

### DETAILED DESCRIPTION OF EMBODIMENTS

In the following further exemplary embodiments of a solar module arrangement, a fixed solar module arrangement, a method of assembling a solar module arrangement, and the method of reassembling a solar module arrangement will be explained. It should be noted that the description of specific features described in the context of one specific exemplary embodiment may be combined with others exemplary embodiments as well.

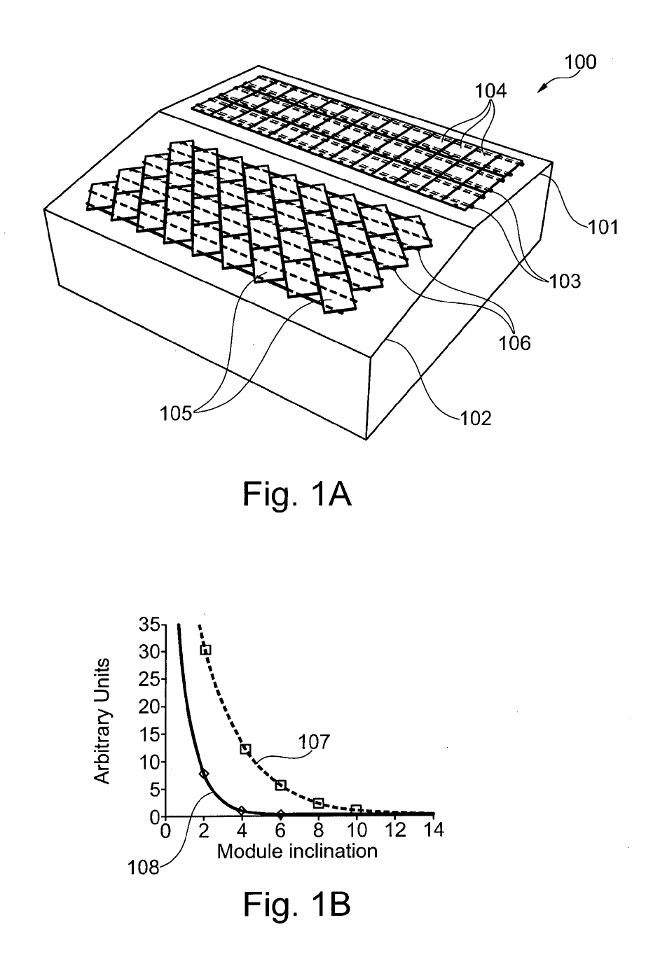

FIGS. 1A and 1B schematically illustrate a comparison between a common solar module arrangement and a solar module arrangement according to an exemplary embodiment. In particular FIG. 1A shows a schematic perspective view of a building 100 having a slanted roof, wherein in a first half 101 of the slanted roof a common solar module arrangement is shown, while in a second half 102 a solar module arrangement according to an exemplary embodiment is shown.

In the first half 101 a plurality of mounting rods 103 are attached to the slanted roof, which are parallel to each other. A plurality of rectangular framed solar module elements 104 are mounted or clamped to the mounting rods 103 in a way that a side element of the frame structure is parallel to the mounting rods 103 or that the line of the greatest slope of the main surfaces of the solar module elements is perpendicular to the side element intersecting the line of the greatest slope (or gradient).

Contrary to the arrangement of the first half 101, the arrangement of the second half 102 is different in that a corresponding plurality of framed solar module elements 105 is turned or rotated in an angle about 45°. Thus, the plurality of rectangular framed solar module elements 105 are mounted or clamped to a plurality of mounting rods 106 in a way that a side element of the frame structure is slanted to the mounting rods 106 or that the line of the greatest slope of the main surfaces of the solar module elements form a slanted shifting angle with respect to the side element intersecting the line of the greatest slope (or gradient).

Thus, it may be possible that rain water falling on the main surface of the solar module elements 105 in the second half 102 does not flow in an angle perpendicular to a rim formed by the frame structure but flows along a slope or gradient to the lowest point of the main surface or frame structure. On contrary to that in the first half 101 the rainwater will collect at a rim formed by the corresponding frame structure. Therefore, the amount of rain water hold back by the frame structure may be smaller in the second half 102, so that at a same inclination angle of the main surfaces less area of the solar module element may be covered by rain water and dirt which may possibly increase the efficiency of the solar module element and the overall solar module arrangement.

The general effect on the lowest cell of each solar module element is shown in FIG. 1B. In particular, FIG. 1B shows qualitative the portion or percentage covered by rainwater, for different inclination angles of the solar module element for the common arrangement of the first half 101 (graph 107) and the solar module arrangement according to an exemplary embodiment in the second half 102 (graph 108), having module elements turned by 45°.

It should be noted that due to the reduced amount of water covering the main surface of the solar module elements, it may possible to reduce the inclination angle of the arrangement without increasing problems induced by pollution of the surface when compared to the common arrangement as shown in the first half 101. Furthermore, it may be possible to use one and the same mounting structure (already installed on a slanted roof, for example) for a reassembling of the solar module arrangement, by removing the commonly oriented solar module elements turn the same and mounting or clamping the same to the same mounting rods but in the turned orientation as shown in the second half 102. In particular, it may even be possible to use the same components.

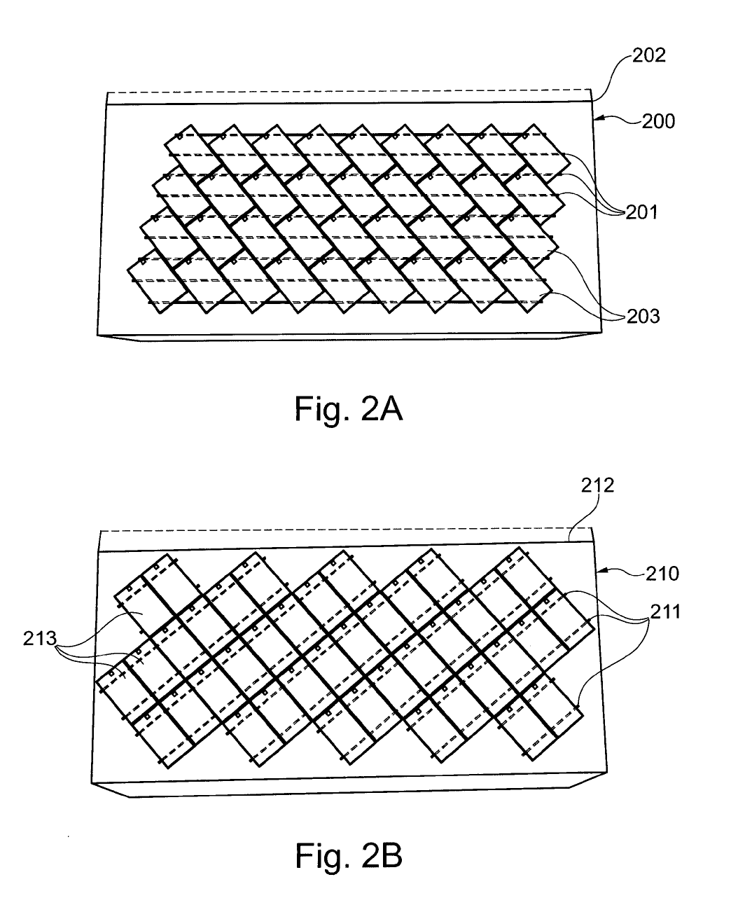

FIGS. 2A and 2B each schematically illustrates a solar module arrangement according to an exemplary embodiment. In particular, FIG. 2A shows the same arrangement or mounting variant as in FIG. 1A in the second half 102. On a slanted roof 200 a plurality of mounting rods 201 are mounted or attached. The mounting rods are parallel to each other and parallel to the roof ridge 202. A plurality of rectangular solar module elements 203 are mounted or clamped to the plurality of mounting rods 201 so that they are slanted (angle of about 45°) with respect to the direction of the plurality of mounting rods 201 but more importantly as well to the direction of the roof ridge 202 or the line of the greatest slope being perpendicular to the direction of the mounting rods and the roof ridge.

That the relative direction between the mounting rods and the solar module elements is not of importance but the relative direction between the solar module elements and the line of the greatest slope or gradient can be seen in FIG. 2B showing another orientation of the mounting rods. In FIG. 2B mounting rods 211 are mounted to a slanted roof 210 at a slanted angle of about 45° to the roof ridge 212. In this case a plurality of solar module elements 213 are attached or mounted to the plurality of mounting rods in a parallel or right angle configuration.

It should be mentioned that the mounting rods can be attached to the slanted roof in all desired orientation. Of primary importance is the orientation of the solar module elements with respect to the line of greatest slope. The direction of the mounting rods (relative to the roof ridge) may be chosen so that common framed solar module elements typically having mounting elements or mounting areas at predetermined positions can be used in order to enable the slanted orientation of the solar module elements. This will be explained in more detail in the context of the next figure.

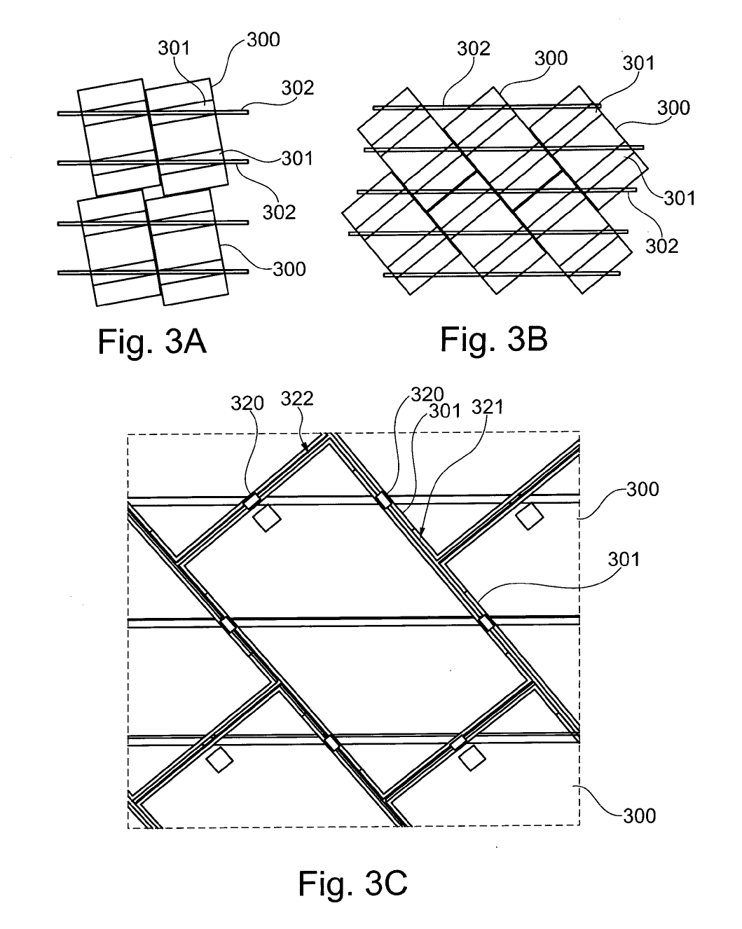

FIGS. 3A to 3C schematically illustrate mounting variants which may be used in a solar module arrangement according to an exemplary embodiment. In particular, FIG. 3A schematically shows a plurality of rectangular solar module elements 300 from below each comprising two mounting areas 301 as typical in this technical field. Furthermore, a plurality of mounting rods 302 are shown (in an orientation which may be parallel to a roof ridge of a slanted roof, for example). According to FIG. 3A the solar module elements 300 are only slightly turned or rotated with respect to the direction of the mounting rods 302. In this case each mounting area 301 will be mounted to a single mounting rod 302. Thus, leading to a small slanted angle between the line of the greatest slope (gradient) and the small side of the rectangular solar module elements 300.

In FIG. 3B an embodiment is shown wherein the plurality of solar module elements 300 is turned about 45°, i.e. a substantial amount. Therefore, one mounting area 301 of one solar module element 300 is mounted to two different mounting rods 302. With respect to the self-cleaning of the solar module elements a slanted angle of about 45° may be the optimum.

In case the modules are turned with respect to the mounting rods a substantial amount further optional mounting points may arise as can be seen in FIG. 3C showing in principle the same variant as FIG. 3B. However, beside from the mounting areas 301 additional mounting elements 320 are shown in FIG. 3C, which are used in connection with the mounting areas 301 and in additional areas of the solar module elements. In this case, two mounting elements of neighboring sides (e.g. sides 321 and 322) are attached or mounted on a single mounting rod. Thus, the resulting arrangement may be more robust or stable.

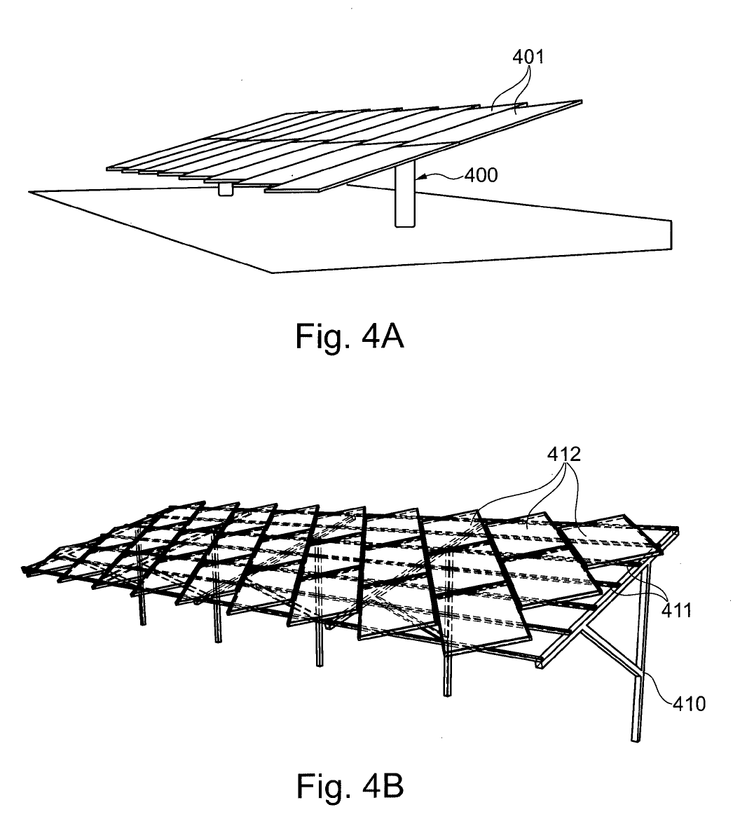

FIGS. 4A and 4B each schematically illustrates mounting variant of a field arrangement of a solar module arrangement (a so-called ground-mounted installation) according to an exemplary embodiment. In particular, FIG. 4A schematically illustrates a mounting structure 400 arranged on ground. On this mounting structure a plurality of rectangular solar module elements 401 are arranged forming an (with respect to a horizontal plane) inclined surface. As indicated in FIG. 4A the solar module elements 401 are slightly turned or rotated so that the small sides of its rectangular frame intersect the gradient caused by the inclination at a slanted angle. Thus, the frame may not cause that a high amount of rain-water is hold back on the surface of the solar module element even when only a small inclination angle is used. Thus, the self-cleaning effect of the turned or rotated mounting may enable a smaller inclination angle and consequently possibly a higher field coverage or ground coverage ratio without shadowing effects between neighboring arrangements.

FIG. 4B schematically illustrates that mounting structures built for common mounting can be reused. In particular, FIG. 4B shows a common fixed mounting structure 410 which can be arranged on ground and having a plurality of parallel mounting rods 411 defining an inclined plane. On the mounting rods 411 a plurality of rectangular solar module elements 412 are mounted so that the sides of the solar module elements form a slanted angle (about 45° for example) with the direction of the mounting rods 411.

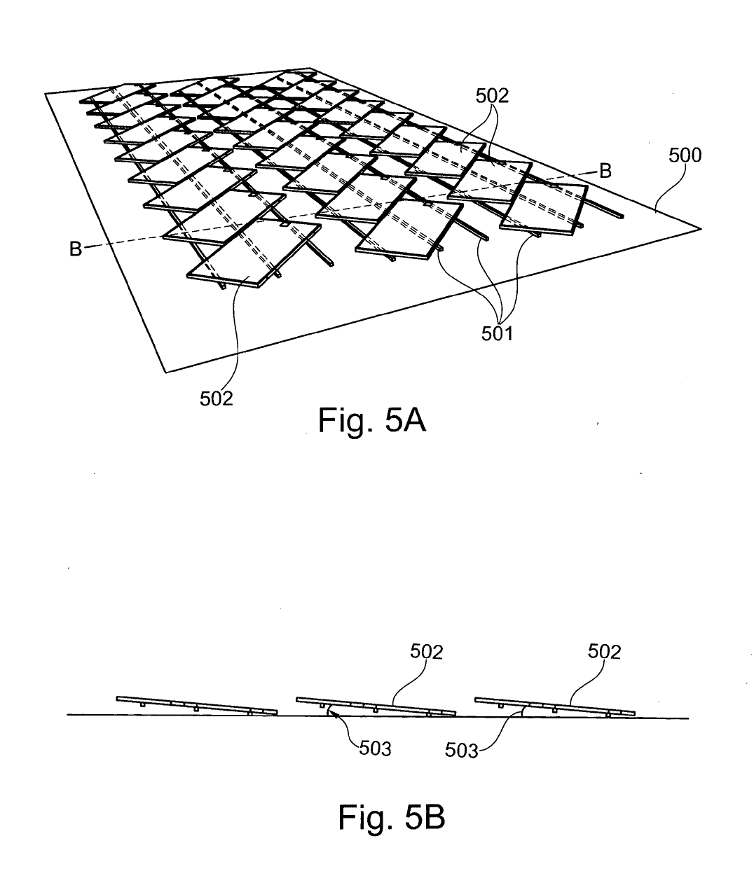

FIGS. 5A and 5B schematically illustrate different views of a flat roof mounting of a solar module arrangement according to an exemplary embodiment. In particular, FIG. 5A schematically shows a flat roof 500 on which a plurality of parallel mounting rods 501 is mounted. Onto the mounting rods 501 a plurality of rectangular solar module elements 502 are mounted at a slanted angle and at a small inclination angle 503 which can be seen in FIG. 5B showing a cross-section of the solar module arrangement of FIG. 5A along line B-B.

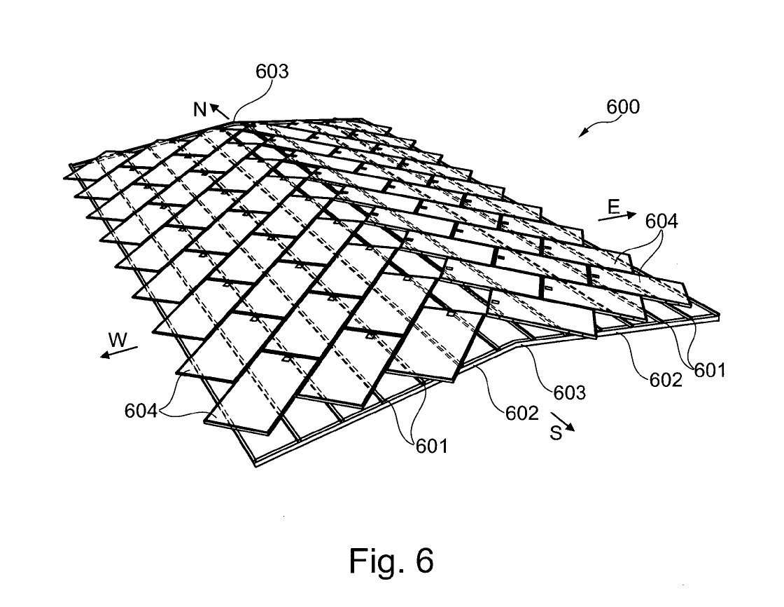

FIG. 6 schematically shows a field arrangement of an east-west arrangement according to an exemplary embodiment. In particular, FIG. 6 schematically shows a solar module arrangement 600 comprising a mounting structure indicated by a plurality of parallel mounting rods 601 connected to each other by connection elements 602. The connection elements 602 are not straight but comprising kink 603. Therefore, the parallel mounting rods 601 form two planes angled to each other and reproduce a slanted roof. Onto the mounting rods 601 a plurality of rectangular (planar) solar module elements 604 are mounted in a slanted way. Preferably, the overall solar module arrangement is oriented in a so-called east-west orientation meaning that the two planes formed by the mounting structures facing in an (substantially) east and west direction. Thus, an east-west direction may be described by the fact that normal vectors of a plane or surface defined by the surfaces of the solar module elements are directing substantially into a west and east direction, respectively. In other words a ridge formed by the kink line 603 is (substantially) directing in a north-south direction.

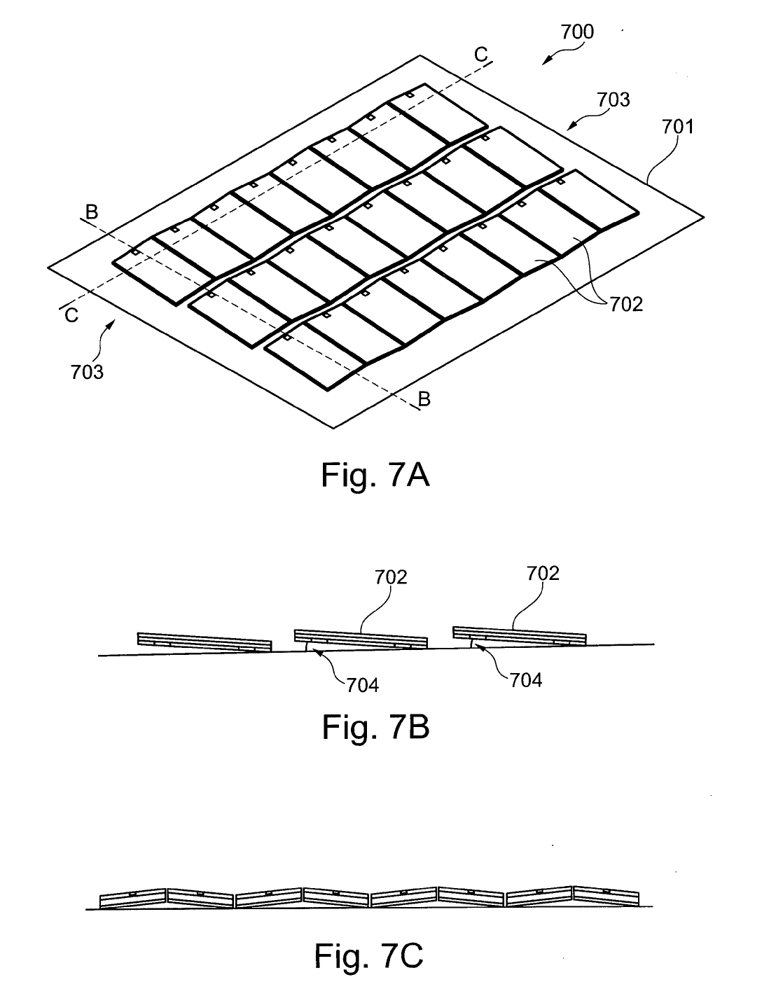

FIGS. 7A to 7C schematically illustrate different views of a flat roof mounting of a solar module arrangement according to an exemplary embodiment. In particular, FIG. 7A shows a solar module arrangement 700 which may be used on a flat roof 701. A plurality of solar module elements 702 are arranged on the flat roof 701. The solar module elements 702 are arranged in rows 703 and having an inclination angle perpendicular to the row orientation (704 in FIG. 7B). Furthermore, adjacent solar module elements are oriented angled to each other as well. Thus, the surfaces of two solar module elements arranged adjacent in a row do not have parallel surfaces (FIG. 7C). However, a solar module element arranged adjacent but in another row has in principle the same orientation and thus form a (substantially) parallel surface or plane.

It should be noted that the orientation of the solar module elements with the (horizontal) orientation of the flat roof may be achieved by tilting or turning horizontally arranged solar module elements around two axes. One axis is given by the short side of the rectangular solar module element which leads to an inclination as depicted in FIG. 7B. A further tilting is performed around the longitudinal side of the solar module element. In particular, adjacent solar module elements of one row may be tilted in opposite directions (but for the same amount) leading to the orientation as depicted in FIG. 7C. For clarity reasons it should be mentioned that the two axes depend on the orientation of the solar module elements. For example, the second axis may be given by the long axis in case the solar module elements are mounted in a “landscape format” instead of the depicted “portrait format”.

FIG. 7B schematically shows a cross-section of the arrangement of FIG. 7A along line B-B while FIG. 7C schematically shows a cross-section of the arrangement of FIG. 7A along line C-C.

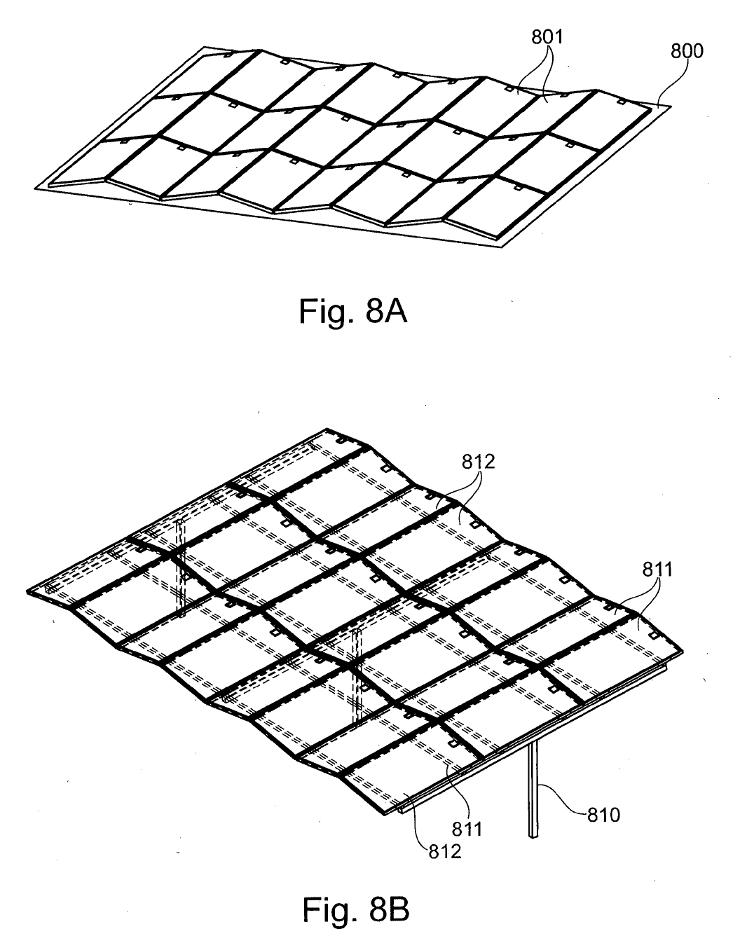

FIGS. 8A and 8B schematically illustrate different variants of an arrangement mounted on an inclined surface formed by an inclined (slanted) roof and a mounting structure installed on (flat or sloped) ground but providing an inclined mounting surface, respectively according to an exemplary embodiment. In particular, FIG. 8A schematically shows the principle solar module arrangement of FIG. 7 mounted on a slanted roof 800. Thus, a first tilt (in FIG. 8A) around a short side of the rectangular solar module elements 801 is introduced or caused by the slanted or inclined roof already. In addition, (as in FIG. 7) a second tilt is made around the longitudinal side of the solar module elements leading to a zigzag arrangement as shown in FIG. 7C. It should further be noted that the solar module elements may be arranged as well in a herringbone pattern, or any other suitable regular or even irregular pattern. That is, the zigzag arrangement shown in FIG. 8A may be formed with any desired pattern.

FIG. 8B schematically shows a field arrangement (or installation mounted on a flat ground) of the variant shown already in FIG. 8A which is mounted on a mounting structure 810 forming an inclined surface by the way of parallel mounting rods 811 onto which a plurality of solar module elements 812 are mounted in the same way as shown in FIG. 8A or FIG. 7A forming a zigzag cross-section.

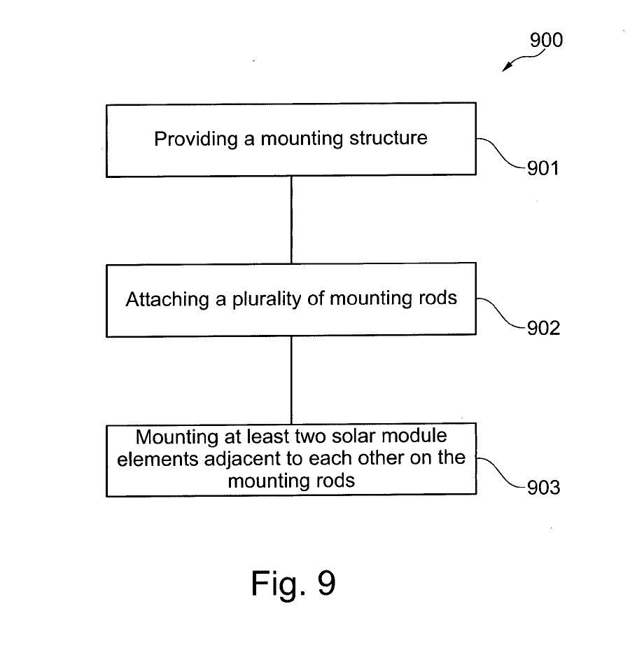

FIG. 9 depicts a flowchart of a method 900 of assembling a solar module arrangement according to an exemplary embodiment. In particular, FIG. 9 illustrates the method 900 comprising providing a mounting structure providing a surface having a plurality of mounting rods thereon for mounting a solar module arrangement (step 901). In particular, the plurality of mounting rods may be attached to the provided surface or may form a part of the surface, e.g. in case of an undulated roof. Furthermore, it should be noted that also the erecting of a mounting structure comprising a plurality of mounting rods may fall under this process step. Furthermore, at least two solar module elements are mounted adjacent to each other on the mounting rods (step 903). The mounting is performed in a way that the main surfaces of the at least two adjacent solar modules are arranged parallel to each other and that the main surfaces of the solar module elements have a line of the greatest slope which forms a slanted shifting angle with respect to the side element of the frame structure which intersects with the line of the greatest slope.

It should also be noted that the term “comprising” does not exclude other elements or features and the “a” or “an” does not exclude a plurality. Also elements described in association with different embodiments may be combined. It should also be noted that reference signs shall not be construed as limiting the scope of the claims. While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. Throughout the whole description the word “exemplary” is used to mean “serving as an example, instance, or illustration”. Any embodiment, aspect or design described herein as “exemplary” is not necessarily to be construed as preferred or advantageous over other embodiments or designs.

1: A solar module arrangement comprising:
at least two solar module elements each comprising a frame structure formed by a plurality of side elements and each comprising a main surface;
wherein the two solar module elements are assembled adjacent to each other;
wherein the main surfaces of the two solar module elements are arranged parallel to each other; and
wherein the solar module arrangement is arranged so that the main surface of the solar module elements has a line of greatest slope which forms a slanted shifting angle with respect to the side element of the frame structure which intersects with the line of the greatest slope.

2: The solar module arrangement according to claim 1, wherein the frame structure has a rectangular form.

3: The solar module arrangement according to claim 1, wherein the solar module elements comprises mounting elements at at least two neighboring sides of the solar module elements.

4: The solar module arrangement according to claim 3, further comprising at least one mounting rod, wherein the mounting elements of neighboring sides of a single solar module element are attached to a single mounting rod.

5: The solar module arrangement according to claim 1, wherein the solar module elements are arranged in the solar module arrangement that the main surface of each of the solar module elements form an inclination angle with respect to a planar surface.

6: The solar module arrangement according to claim 5, wherein the inclination angle of each solar module element has the same absolute value.

7: The solar module arrangement according to claim 6, wherein the inclination angle has the same sign.

8: The solar module arrangement according to claim 6, further comprising a third solar module element adjacent one of the two solar module elements, wherein the inclination angles of the third solar module element and the adjacent one of the two solar module elements have opposite signs.

9: The solar module arrangement according to claim 5, wherein the planar surface forms a horizontal plane.

10: The solar module arrangement according to claim 5, wherein the planar surface is inclined with respect to a horizontal plane.

11: The solar module arrangement according to claim 1, further comprising a plurality of mounting rods each having a longitudinal direction arranged parallel to each other.

12: The solar module arrangement according to claim 11, wherein the at least one side element of each solar module element forms a slanted angle with the longitudinal direction of the plurality of mounting rods.

13: The solar module arrangement according to claim 11, wherein the longitudinal direction is perpendicular to the line of the greatest slope or forms a slanted angle with the line of the greatest slope.

14: The solar module arrangement according to claim 1, wherein the main surfaces of the two solar module elements have a normal vector having a west orientation or east orientation.

15: A fixed solar module arrangement comprising at least two solar module elements each having a planar main surface having at least one side, wherein the at least two solar module elements are adjacently mounted on a mounting structure, so that the planar main surfaces are equally tilted out of a horizontal plane by tilting the main planar surfaces around two axes out of the group consisting of:
a first axis perpendicular to the planar main surface;
a second axis perpendicular to the first axis and parallel to the at least one side; and
a third axis perpendicular to the first and second axis.

16: A method of assembling a solar module arrangement comprising at least two solar modules each having at least one side and each comprising a main surface, the method comprising:
providing a mounting structure providing a surface having a plurality of mounting rods thereon for mounting a solar module arrangement;
mounting the at least two solar module elements adjacent to each other on the mounting rods so that the main surfaces of the at least two adjacent solar modules are arranged parallel to each other and that the main surfaces of the solar module elements have a line of the greatest slope which forms a slanted shifting angle with respect to the side which intersects with the line of the greatest slope.

17. (canceled)

18: The solar module arrangement according to claim 2, wherein the frame structure of each of the solar module elements includes a first side, a second side, a third side and a fourth side, and wherein at least one of the solar module elements further comprising:
at least one first mounting element associated with the first side and at least one second mounting element associated with the second side, the first and second mountings being attached to a first mounting rod;
at least one third mounting element associated with the second side and at least one fourth mounting element associated with the fourth side, the third and fourth mountings being attached to a second mounting rod parallel with the first mounting rod; and
at least one fifth mounting element associated with the third side and at least one additional sixth mounting element associated with the fourth side, the fifth and sixth mountings being attached to a third mounting rod parallel with the first mounting rod.

19: The solar module arrangement according to claim 2, wherein the frame structure of each of the solar module elements includes a first side and a second side, and wherein at least one of the solar module elements further comprising:
at least a first mounting area associated with the first side and with the second side, wherein the first mounting area is attached to a first mounting rod; and
at least a second mounting area associated with the first side and with the second side, wherein the second mounting area is attached to a second mounting rod parallel with the first mounting rod.

20: The solar module arrangement according to claim 2, wherein the frame structure of each of the solar module elements includes a first side and a second side, and wherein at least one of the solar module elements further comprising:
at least a first mounting area associated with the first side, wherein the first mounting area is attached to a first mounting rod;
at least a second mounting area associated with the first side and with the second side, wherein the second mounting area is attached to a second mounting rod; and
at least a third mounting area associated with the second side, wherein the third mounting area is attached to a third mounting rod parallel with the first mounting rod.
